(19) United States
(12) Patent Application Publication
(10) Pub. No.: US 2026/0044796 A1
(43) Pub. Date: Feb. 12, 2026

(54) ADAPTIVE SCHEDULE-SHIFT REAL-TIME OPTIMIZER

(71) Applicant: NICE LTD., Ra'anana (IL)

(72) Inventors: Sinaya OVED, Yehud (IL); Noam KAPLAN, Tel-Aviv (IL); Eyal SEGAL, Ramat Gan (IL); Eliya SHTRASER, Talmon (IL)

(21) Appl. No.: 18/796,348

(22) Filed: Aug. 7, 2024

(51) Int. Cl. G06Q 10/0631; G06F 16/901

(52) U.S. Cl. CPC G06Q 10/063116; G06F 16/9024

(57) ABSTRACT

A computerized-method for operating intraday schedule optimization in real-time for a schedule having one or more time-intervals, in a contact-center. The computerized-method includes: (i) retrieving current-state data of the contact center for each time-interval in the schedule; (ii) generating a current-schedule-state node that includes the received current-state data of the contact center; (iii) generating a directed-graph of a plurality of updated-schedule-state nodes; (iv) applying a model to predict SLA-level for each updated-schedule-state node in the generated directed-graph; (v) applying a heuristic search graph algorithm on the generated directed-graph of the plurality of updated-schedule-state nodes based on the SLA level of each updated-schedule-state node in the generated directed-graph as a heuristic to yield a path in the directed-graph of updated-schedule-state nodes; (vi) updating the schedule in the contact center based on the change in agents activities of each edge in the yielded path in the updated-schedule-state nodes in the path.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of change management intraday schedule optimization in real-time or near real-time for a schedule having one or more time-intervals, in a contact-center.

### BACKGROUND

In the domain of managing work schedules in contact centers, a single change can create a gap between the current staffing plan and what has been predicted, including aspects like the number of agents needed, service quality, response times, and more. When multiple changes occur, the gap can become even larger and needs to be addressed by workforce managers in charge of scheduling. They may need to adjust scheduled process, remove non-essential activities, or even request employees to work extra hours.

Currently, this process is either performed manually by users, which may be time consuming and requires expertise, or by using automated rule-based systems and tools, such as Employee Engagement Manager (EEM) application. However, these tools have limitations, such as having a narrow focus, offering one-size-fits-all solutions, and requiring a high level of technical skill to manage effectively.

Accordingly, there is a need for a technical solution that will create a flexible system that will evaluate multiple issues at once, such as understaffing on specific skill and high volume on another skill and low SLA for one or more multiple skills and will find the best solution with the most significant impact at the lowest cost of making the change. To evaluate these issues the following parameters may be required, costs of making changes in the schedule, the importance and impact of different tasks in the schedule, the preferences of the contact center, and the well-being of agents and customer satisfaction.

There is a need for a technical solution that will operate intraday schedule optimization in real-time for a schedule having one or more time-intervals, in a contact-center and provide a suggestion of the best sets of adjustments that solve multiple problems with minimum cost.

### SUMMARY

There is thus provided, in accordance with some embodiments of the present disclosure, a computerized-method for to choose the best possible schedule adjustments from a wide range of options.

In accordance with some embodiments of the present disclosure, the computerized-method may include: (i) retrieving current-state data of the contact center for each time-interval in the schedule from an agents-database. The current-state data may include a. staffing requirements for each skill; b. agents activities; and c. agents skills for each agent; (ii) generating a current-schedule-state node that includes the received current-state data of the contact center; (iii) generating a directed-graph of a plurality of updated-schedule-state nodes. Each updated-schedule-state node in the updated-schedule-state nodes indicates a state of the contact-center represented after a change in agents activities and a distance between actual staffing and the staffing requirements for all skills, and each edge in the directed-graph of the plurality of updated-schedule-state nodes indicates a cost of the change in agents-activities by moving between two nodes in the directed-graph of updated-schedule-state nodes; (iv) applying a model to predict Service Level Agreement (SLA) level for each updated-schedule-state node in the generated directed-graph; (v) applying a heuristic search graph algorithm on the generated directed-graph of the plurality of updated-schedule-state nodes based on the SLA level of each updated-schedule-state node in the generated directed-graph as a heuristic to yield a path in the directed-graph of updated-schedule-state nodes. The path is combined of one or more edges, and (vi) updating the schedule in the contact center based on the change in agents activities of each edge in the yielded path in the updated-schedule-state nodes in the path. The agents-database may include agent schedules, forecasted data, staffing requirements and agent skills.

Furthermore, in accordance with some embodiments of the present disclosure, the model to predict the SLA level may be at least one of: (i) Machine Learning (ML) model; (ii) Erlang C formula; and (iii) simulations of incoming interactions and related expected length with agents. The model may predict the SLA level based on the actual staffing, e.g., agents schedules for each skill in the updated-schedule-state node and staffing requirements.

Furthermore, in accordance with some embodiments of the present disclosure, the heuristic search graph algorithm may be using the SLA level of each updated-schedule-state node as heuristic by comparing the SLA level of each updated-schedule-state node to a preconfigured target-SLA level.

Furthermore, in accordance with some embodiments of the present disclosure, the current state data may further include activities which are not in the schedule for each agent.

Furthermore, in accordance with some embodiments of the present disclosure, the heuristic search algorithm may be A*-search algorithm.

Furthermore, in accordance with some embodiments of the present disclosure, the agents activities may be one of: (i) open to receive interactions from customers; (ii) break; (iii) training; (iv) lunch; (v) Voluntary Time-Off (VTO); (e) outbound interactions and back-office tasks; and (f) extra-hours.

Furthermore, in accordance with some embodiments of the present disclosure, the heuristic search graph algorithm on the generated directed-graph of updated-schedule-state nodes may include: (i) extending the updated-schedule-state node having the SLA level above the preconfigured SLA-threshold in the directed-graph of updated-schedule-state nodes and the minimum accumulated cost to yield the path from the current-state node to the updated-schedule-state node having the SLA level above the preconfigured SLA-threshold; and (ii) storing all updated-schedule-state nodes in a database as the path.

Furthermore, in accordance with some embodiments of the present disclosure, the cost of moving between two nodes in the directed-graph of updated-schedule-state nodes may indicate cost of the change in agents activities and it is determined by a preconfigured dictionary of action costs.

Furthermore, in accordance with some embodiments of the present disclosure, the extending of the updated-schedule-state node having the SLA level above the preconfigured SLA-threshold may be operated during a running-time limit and when there is no updated-schedule-state node having an SLA level above the preconfigured SLA-threshold during the running-time limit: (i) extending the updated-schedule-state node having the SLA level in a preconfigured distance below the SLA level and the minimum accumulated cost to yield the path from the current-state node to the updated-schedule-state node having the SLA level in the preconfigured distance below the SLA level; and (ii) storing all updated-schedule-state nodes in a database as the path.

Furthermore, in accordance with some embodiments of the present disclosure, the computerized-method may further include applying the model to predict SLA for the current state of the contact-center based on the received current state data and operating the generating of the directed-graph of the plurality of updated-schedule-state nodes when the yielded SLA level is below a preconfigured SLA-threshold.

Furthermore, in accordance with some embodiments of the present disclosure, one or more updated-schedule-state nodes in the plurality of updated-schedule-state nodes are successors of the current-state node, and the one or more updated-schedule-state nodes may be predecessors of other updated-schedule-state nodes in the plurality of updated-schedule-state nodes.

Furthermore, in accordance with some embodiments of the present disclosure, the updating of the schedule in the contact center may be operated via a Workforce Management (WFM) application.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIGS. 1A-1B schematically illustrate a high-level diagram of a computerized-system for operating intraday schedule optimization in real-time for a schedule having one or more time-intervals, in a contact-center, in accordance with some embodiments of the present invention;

FIGS. 2A-2B schematically illustrate a high-level flowchart of a computerized-method for operating intraday schedule optimization in real-time for a schedule having one or more time-intervals, in a contact-center, in accordance with some embodiments of the present invention;

FIG. 3 schematically illustrates a directed-graph, in accordance with some embodiments of the present invention;

FIG. 4 schematically illustrates a high-level flowchart of heuristic search graph algorithm, in accordance with some embodiments of the present invention;

FIG. 5 shows schedules before optimization and after, in accordance with some embodiments of the present invention;

FIG. 6 is a screenshot of User Interface (UI) to track optimization plans, in accordance with some embodiments of the present invention;

FIG. 7 is a screenshot of a UI of a schedule adjustment, in accordance with some embodiments of the present invention;

FIG. 8 is a screenshot of a UI of the schedule adjustment with a graph showing the variance from required staffing, in accordance with some embodiments of the present invention;

FIGS. 9A-9B schematically illustrate a high-level diagram of schedule optimizer manager, in accordance with some embodiments of the present invention; and

FIG. 10 shows a graph of results of schedule optimization, in accordance with some embodiments of the present invention.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

As used herein, the term “staffing requirements” refers to the number of agents needed to answer all expected inbound interactions for a contact center in a given time-interval. The expected inbound interactions may come via various digital channels as calls, SMS, email, chat, video, etc.

Current technical solutions for automatically optimizing schedules in contact centers, use a rule-based approach and lacks an overall understating such that they can't provide an efficient solution and they also requires substantial maintenance. Also, current solutions may provide suboptimal outcomes, as it solves problems by using a limited scope of considerations in a shortsighted manner, without striving for the best possible solution.

Moreover, current solutions for schedule optimization require specific optimizations that can be defined, using an if-else nested rule infrastructure that might require the manual definition of many rules and each nested rule might have many if-else rules. Another deficiency is that different rules might contradict each other, and the user may end up with a very vague view of which optimizations will actually take place under different situations.

For example, in a contact center during a day in which there is a high volume of inbound interactions and a few agents have called sick, then with current technical solutions, a user may have to make sure that there is one rule to assign extra hours, one rule to adjust break activities and one rule to make other schedule changes. Each rule process works as a standalone without considering other rules suggestions. The problem in current solutions is that in such scenario, the user has to closely manage the rules and the execution which results in high maintenance and high amount of time allocation to closely monitor it.

Accordingly, there is a need for a technical solution that will examine all possible changes for the schedule to be optimized by considering all possible actions and will provide multiple actions, e.g., changes to the schedule and suggested agents.

There is a need for a technical solution that will optimize the schedule by considering all problems and optional solutions as one problem set where each action will be selected to be included in the multiple actions, based on its impact on the schedule, and cost of the change to the schedule.

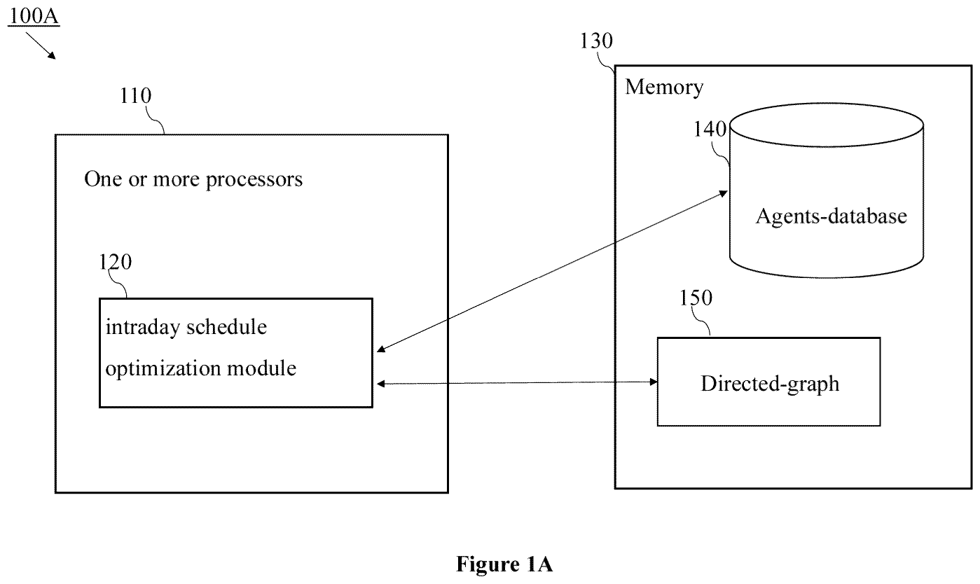

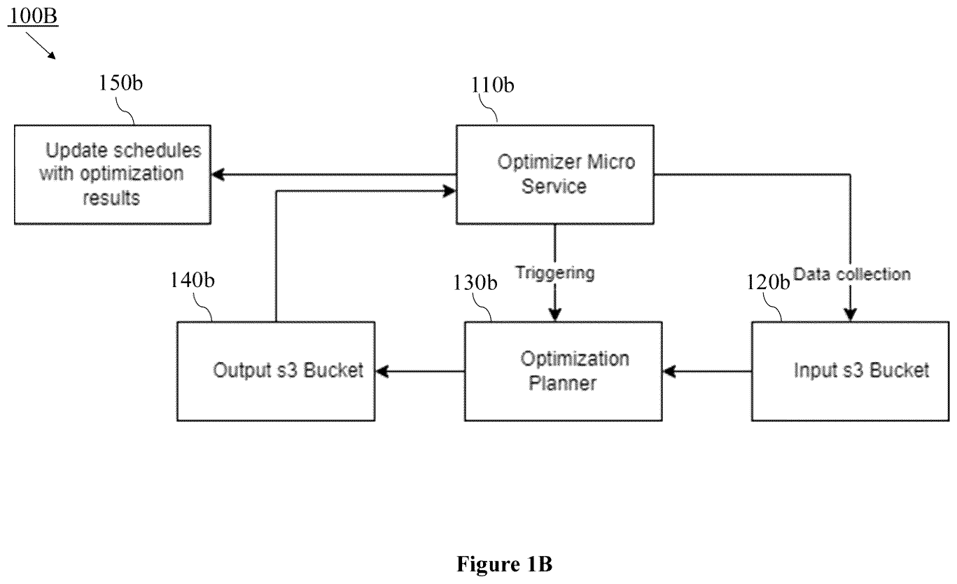

FIG. 1A schematically illustrates a high-level diagram of a computerized-system 100A for operating intraday schedule optimization in real-time for a schedule having one or more time-intervals, in a contact-center, in accordance with some embodiments of the present invention.

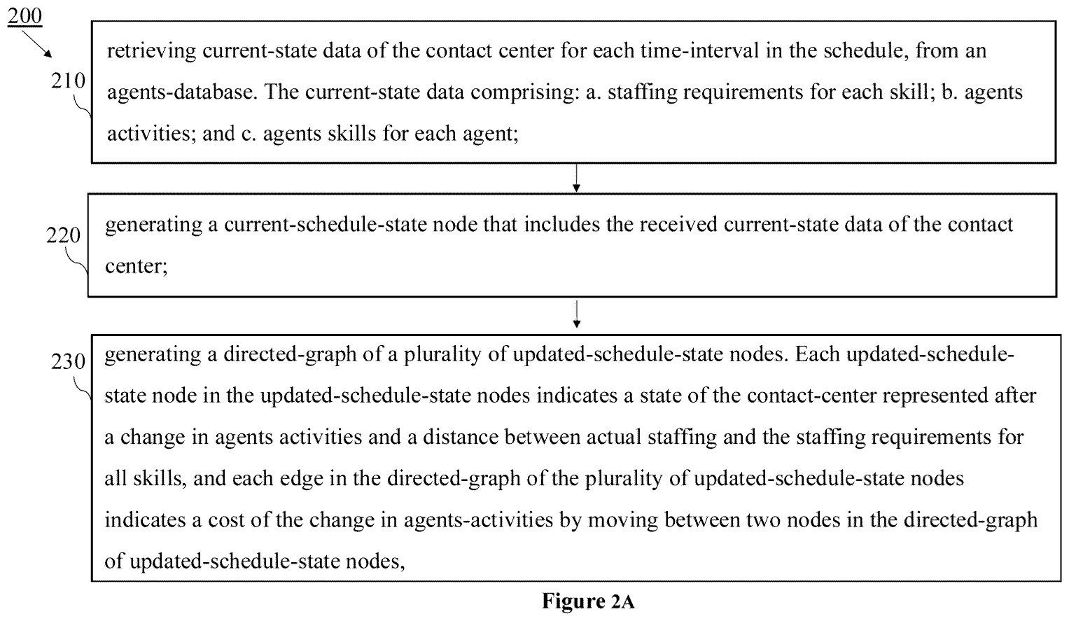

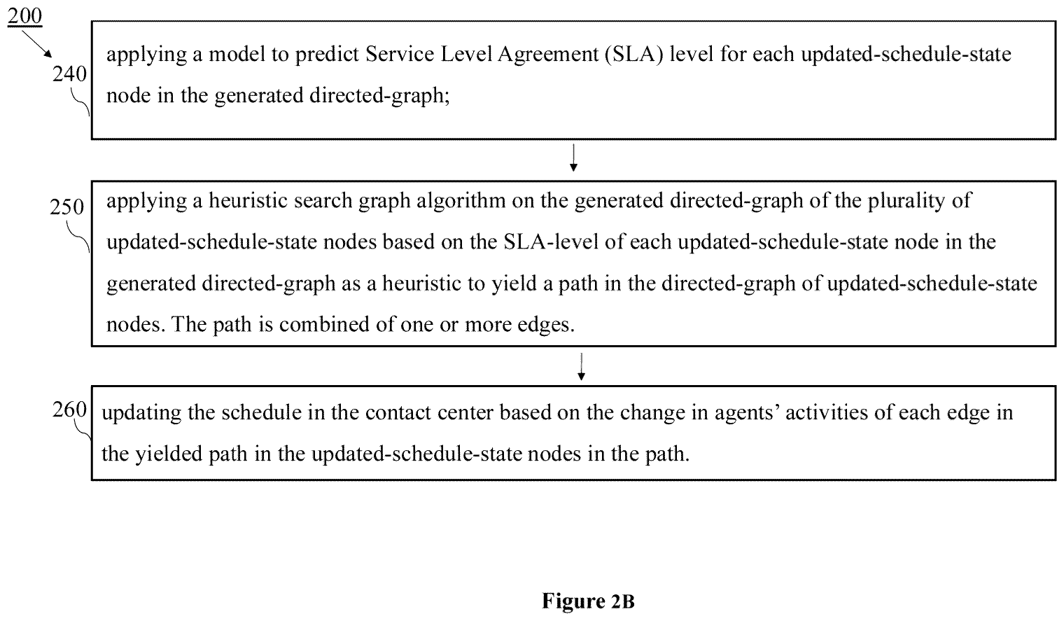

According to some embodiments of the present disclosure, a system, such as system 100A may operate one or more processors 110 which may be configured to operate an intraday schedule optimization module 120, that may implement the computerized-method 200 in FIGS. 2A-2B for operating intraday schedule optimization in real-time for a schedule having one or more time-intervals, in a contact-center. The contact center may provide service over digital channels.

According to some embodiments of the present disclosure, system 100A may consider existing contact center regulations and working rules. System 100A may provide schedule optimizations in real-time for a schedule having one or more time-intervals and may address issues, considering the preferences and fairness of all agents in the contact center.

According to some embodiments of the present disclosure, system 100A may not necessitate advanced knowledge of the contact center and may not involve maintaining rule creation and adjusting parameters, as current technical solutions do. System 100A may provide suggestions based on existing working rules and preferences which are being used for schedule generation via an application, such as Workforce Management (WFM) application once triggered.

According to some embodiments of the present disclosure, system 100A may employ a heuristic search graph algorithm within the workforce management domain and may recognize that different users, e.g., supervisors, have varying preferences. Unlike most solutions that attempt to optimize a fixed heuristic, assuming a one-size-fits-all solution exists, system 100A may allow for user customization and may support different heuristics for each user.

According to some embodiments of the present disclosure, the heuristic may be based on an estimation of the time distributions of the agents. That can be achieved by splitting the agent's time between all the skills equivalently, or proportionally to their forecasted workload. The staffing is then subtracted from the requirements and the difference is then multiplied by a user-configurable parameter.

According to some embodiments of the present disclosure, a Machine Learning (ML) model may be utilized using a Deepsets architecture by which the ML model is learning on sets, such that the input is in the form of a set of items in a permutation invariance. This approach allows using an ML model to estimate the Service Level Agreement (SLA) level for each state of the contact center, e.g., based on the actual staffing e.g., agents schedules, for each skill in the updated-schedule-state node.

According to some embodiments of the present disclosure, the Deepsets architecture utilized by the ML model performs a transformation of multi-skilled agents into single skilled agents within the ML model. The ML model may be trained by implementing artificial neural networks (ANN)s to learn patterns from data of volumes over different skills and channels, Average Handling Time (AHT) over different skills, customer latency and a group or a set of agents with the skills of each agent separately. The trained ML model may predict the SLA based on the set of agents, each agent having related skills in a schedule.

According to some embodiments of the present disclosure, each agent may be processed by the ML model separately with and agent representation model an advanced layer in the ANN that enables to process agents and their skills, that is an ANN and then the separate representations of all agents in the schedule may be merged into one agents-set in a set transformation box. The separate representation for agents allows for accounting of agent specific traits, such as proficiency over different skills.

According to some embodiments of the present disclosure, the transformation box may transform the single-skill sum of agent time representation into a multi-skilled agent representation. The set transformation box may transform an original candidate set of skills into a group of multi-skilled agents that are likely to originate from the contact center. On the one hand, to keep agents multi-skilled but not to greedily assign agents all skills. On the other hand, not to under use multi-skilled agents, as utilizing them properly may result in an increase in efficiency of the process of generating staffing requirements.

According to some embodiments of the present disclosure, the trained ML model may rely on a distribution of multi-skilled agents available in the contact center and may not recommend staffing of minimum number of agents who possess all required skills. If for example, only 10% of the contact center's agents have skills A, B and C, then, the ML model may not generate a staffing requirement that relies completely on the 10% agents but may include agents from the rest of the 90% agents.

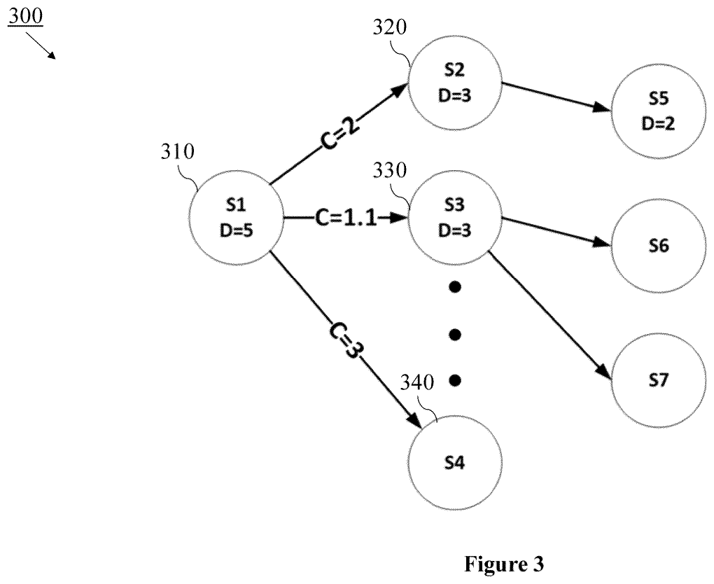

According to some embodiments of the present disclosure, the predicted SLA may be then used as a heuristic for the heuristic search graph algorithm, such as A*-search algorithm, on a directed-graph, such as directed-graph 300 in FIG. 3. If the SLA is 100%, then the heuristic is 0, which means that a solution has been found.

According to some embodiments of the present disclosure, the directed-graph may be a directed-graph of a plurality of updated-schedule-state nodes. Each updated-schedule-state node in the updated-schedule-state nodes may indicate the state of the contact-center represented after a change in agents activities and a distance between actual staffing and the staffing requirements for all skills.

According to some embodiments of the present disclosure, staffing requirements for each skill for a time-interval in the given period, may be used as an input for the scheduling system, e.g., in the WFM application, that assigns specific agents for a shift. Adding another layer of recommendations in the shape of multi-skilled agents enables the scheduling process to run faster and create more efficient schedules, relying on tenant historical data.

According to some embodiments of the present disclosure, each node in the directed-graph may include the contact center's state in a schedule having one or more time-intervals, from a scheduling point of view and a distance. This state data may include the following parameters. Staffing requirements, which is the number of agents which are required at each time-interval, for each skill. Agent schedules, e.g., actual staffing, which show when each agent is expected to work, e.g., actual staffing, and the activity type of the agent.

According to some embodiments of the present disclosure, for example, the activity type may be ‘open’ to indicate when the agent is open to handle calls, ‘lunch’ for lunch, break, training, Voluntary Time-Off (VTO), outbound interactions, back-office tasks and the like. Agent skills are the skills that each agent can work in. For example, agent ‘A’ can work only on technical support while agent ‘B’ can work on technical support and billing. Available training indicates how many training sessions each agent can have added to the schedule that is being optimized.

According to some embodiments of the present disclosure, the current state data may further include activities which are not in the schedule for each agent. For example, training sessions, additional open time, overtime, and voluntary time off.

According to some embodiments of the present disclosure, the distance in each node in the directed-graph may indicate how overstaffed or understaffed the contact center is, i.e., the current schedule. For example, for three time-intervals in which in the actual staffing there is one agent more than the staffing requirements, then for each of the two skills, the distance may be 3 time-intervals*1 agent*2 skills=6. When there is the same situation, during another part of the day only with understaffing, then the distance is 6, and a total overstaffing or understaffing, e.g., distance of 12. The sum of distances in different time-intervals of the schedule may be calculated with a coefficient or weight before the overstaffing or understaffing number, to indicate the importance of each.

According to some embodiments of the present disclosure, each edge in the directed-graph of the plurality of updated-schedule-state nodes may indicate a cost of the change in agents-activities by moving between two nodes.

According to some embodiments of the present disclosure, the intraday schedule optimization module 120 may operate within a preconfigured time-interval, e.g., 15 minutes, which is faster than the manual work that the users are currently doing. The intraday schedule optimization module 120 may be configured to run such that when it is stopped, it may return an optimized version of the schedule that is better than the original one. Also, running the intraday schedule optimization module 120 within the preconfigured time-interval enables an optimization of the schedule within the period that new information arrives in the contact center.

According to some embodiment of the present disclosure, a data structure, such as minimum heap may be used to decide on the order in which the nodes in the directed-graph of a plurality of updated-schedule-state nodes, may be checked or visited. Every node in the directed-graph may include data of a schedule. The minimum heap may include all the changes that are one change away from the nodes that have been already checked or visited. Each change in the minimum heap may have a score for the net-staffing and the cost of the changes made, e.g., (D(node)+Σ(e∈path) C(e)). D may indicate distance and C may indicate cost. The best schedule may be checked first and then all the nodes which are one change away may be added to the heap. The best node may be the node having the lowest score.

According to some embodiments of the present disclosure, at initialization, the current schedule is inserted to the otherwise-empty heap, e.g., retrieving current-state data of the contact center for each time-interval in the schedule, from agents-database, and specific parameters may be loaded from storage to initialize C, D. For example, the cost of each action, e.g., moving lunch is less expensive than bringing agent from home. The current schedule with actual staffing may have been generated in a WFM application based on forecasts of staffing requirements for each skill.

According to some embodiments of the present disclosure, the cost of moving between two nodes in the directed-graph of updated-schedule-state nodes may indicate the cost of the change in agents activities in the schedule and it may be determined by a preconfigured dictionary of action costs.

According to some embodiments of the present disclosure, C may be defined as the dictionary of action costs, where the costs are user-configurable parameters. In a non-limiting example, 1-move lunch, 2-add training, 5-extra time, 5-VTO and 8-bring agent from home.

According to some embodiments of the present disclosure, the function D may be the distance which may be an estimate of understaffing or overstaffing per skill at each time-interval, squared. Squaring of the estimate of understaffing or overstaffing for the distance may have two benefits. The first is that a positive value, e.g., overstaffing and a negative value, e.g., understaffing may have the same resulting and the greater the value the more significant the impact. The second is that two intervals with values of −2 will have resulting of 8 when they are squared in comparison to one interval with a value of −4 which may result in 16. Thus, since the distance should be minimized the emphasis on understaffing and overstaffing may be evenly emphasized and intervals with larger overstaff or understaff may be more emphasized.

According to some embodiments of the present disclosure, for example, staffing requirements for each skill, agents activities, and agents skills for each agent in the agents schedule. This estimate may be then multiplied by the cost of the schedule being understaffed and the cost of being overstaffed, each of these costs may be a user-configurable parameter.

According to some embodiments of the present disclosure, each node in the directed-graph has its own overstaffing and understaffing values. During the schedule optimization, the node with the lowest overstaffing or lowest understaffing may be searched, as well as the lowest cost of actions to reach this state. The overstaffing and understaffing weights are a means of the contact center to ignore understaffing and long wait time, but to prevent overstaffing and very short waiting times. For example, the understaffing weight can be 3 and overstaffing weight 10.

According to some embodiments of the present disclosure, the current state data may further include activities which are not in the schedule for each agent. For example, training sessions and the like.

According to some embodiments of the present disclosure, the schedule may be represented by timestamp-agent-activity pairs, or an equivalent data frame marking the activity of each agent, e.g., column, performs at each timestamp, e.g., row.

According to some embodiments of the present disclosure, at each step of the heuristic search graph algorithm, the first, which is a minimal node, i.e., minimal score, may be removed from the heap. All possible actions, e.g., schedule changes from that state may be calculated. For each such action e, its cost C(e), the result state, neighbors in the graph S′, and it's heuristic cost D(S\hat{ }′) may be calculated. If S′ is not already within the heap or if D(S′)+Σ_(e∈path) C(e) is not the larger than what is in the heap, S′ may be added to the heap. For example, if there are three nodes in the heap with scores, 1, 4 and 7 and a new node with the score 5 then the new node will be added to the heap in the third place.

According to some embodiments of the present disclosure, the heuristic search graph algorithm on the generated directed-graph of updated-schedule-state nodes may include extending the updated-schedule-state node having the SLA level above the preconfigured SLA-threshold in the directed-graph of updated-schedule-state nodes and minimum accumulated cost to yield the path from the current-state node to the updated-schedule-state node having the SLA level above the preconfigured SLA-threshold and storing all updated-schedule-state nodes in a database, such as agents-database 140, as the path.

According to some embodiments of the present disclosure, the extending of the updated-schedule-state node having the SLA level above the preconfigured SLA-threshold may be operated during a running-time limit and when there is no updated-schedule-state node having the SLA level above the preconfigured SLA-threshold during the running-time limit then extending the updated-schedule-state node having the SLA level in a preconfigured distance below the SLA level and the minimum accumulated cost to yield the path from the current-state node to the updated-schedule-state node having the SLA level in the preconfigured distance below the SLA level, and storing all updated-schedule-state nodes in a database as the path.

According to some embodiments of the present disclosure, to reduce the time of the search of a node within the heap, that is to test if a vertex had already been visited before, a data structure, such as a hash table may be used as a cache. An historical elite with respect to D(elite)+Σ(e∈path)C(e) is kept at the end of each iteration. When the results are reported to the user, the path from the initial state to the elite may be reported. Also, Simplified Memory-bounded Algorithm (SMA), a shortest path algorithm may be used. Elite means the best schedule that has been explored. Meaning, if at any time the search stops for example, when it goes out of time, then the elite may be the best schedule that has been explored.

According to some embodiments of the present disclosure, to avoid the heap data structure consuming too much memory 130, the heap may be substituted with a fixed-sized sorted list. When the list exceeds a given size, the worst, i.e., nodes having the highest score, may be removed from the list's end.

According to some embodiments of the present disclosure, the process of removing the minimal node from the heap may repeat until either the heap is empty, i.e., the graph is exhausted or until the user-allocated time is finished. The computation may be resumed by saving the heap, when more time is later allocated, the search can be resumed from the point it has stopped.

According to some embodiments of the present disclosure, system 100A provides a technical improvement for intraday schedule optimization in real-time by the generating of the directed-graph of a plurality of updated-schedule-state nodes and the predicted Service Level Agreement (SLA) level for each updated-schedule-state node in the generated directed-graph and then applying a heuristic search graph algorithm on the generated directed-graph of the plurality of updated-schedule-state nodes based on the SLA level of each updated-schedule-state node in the generated directed-graph as a heuristic to yield a path in the directed-graph of updated-schedule-state nodes.

According to some embodiments of the present disclosure, the directed-graph of the plurality of updated-schedule-state nodes may be built gradually as the search algorithm is running. The node may be added through editing of the schedules with changes.

According to some embodiments of the present disclosure, the path in the directed-graph may reflect one or more changes in the schedule to transform the current-state schedule to an optimized schedule in minimum cost. The cost of the schedule optimization is the sum of the cost of each change to the schedule to yield the optimized schedule. An optimized schedule may be a schedule where the number of assigned agents for each skill is the nearest to the staffing requirement of the skill with SLA level requirements nearest to 100%.

According to some embodiments of the present disclosure, the model to predict the SLA level based on actual staffing may be at least one of: (i) Machine Learning (ML) model; (ii) Erlang C formula; and (iii) simulations of incoming interactions and related expected length with agents. The SLA level for each actual staffing in the updated-schedule-state node may be predicted by a model, for example, such as described in U.S. application Ser. No. 17/694,784, “System and method for predicting service metrics using historical data” filed on Mar. 15, 2022.

According to some embodiments of the present disclosure, the optimized schedule may be updated in a database, such as agents-database 140 based on the changes in agents activities of each edge in the yielded path in the updated-schedule-state nodes in the path. The updating of the schedule in the contact center may be operated via a Workforce Management (WFM) application. The agents-database may include agent schedules, forecasted data, staffing requirements and agent skills.

According to some embodiments of the present disclosure, optionally, the model to predict the SLA level for the current state of the contact-center may be applied based on the received current state data and the generating of the directed-graph of the plurality of updated-schedule-state nodes may be operated when the yielded SLA level is below a preconfigured SLA-threshold.

FIG. 1B schematically illustrates a high-level diagram of a computerized-system 100B for operating intraday schedule optimization in real-time for a schedule having one or more time-intervals, in a contact-center, in accordance with some embodiments of the present invention.

According to some embodiments of the present disclosure, system 100B may implement similar components as system 100A in FIG. 1A.

According to some embodiments of the present disclosure, optimizer micro service 110b may act as the orchestrator of the system and may handle data collection, triggering optimization planner 130b according to activation rules, and updating the schedules automatically once optimization has been completed.

According to some embodiments of the present disclosure, input S3 bucket 120b may provide for each optimization run of a system, such as system 100A in FIG. 1A, all relevant schedules, daily rules, skills, agents, and staffing requirements.

According to some embodiments of the present disclosure, optimization planner 130b, such as intraday optimization module 120 in FIG. 1A, may be operated by the optimizer micro service 110b. The optimizer planner 130b may retrieve current-state data of the contact center for each time-interval in the schedule, from a database, such as agents-database 140 in FIG. 1A. The current-state data may include staffing requirements for each skill, agents activities, and agents skills for each agent, e.g., actual staffing.

According to some embodiments of the present disclosure, a current-schedule-state node that includes the received current-state data of the contact center may be generated. For example, node 310 in FIG. 3.

According to some embodiments of the present disclosure, a directed-graph of a plurality of updated-schedule-state nodes which may be connected to the current-schedule-state node, may be generated. Each updated-schedule-state node in the updated-schedule-state nodes may indicate a state of the contact-center represented after a change in agents activities and a distance between actual staffing and the staffing requirements for all skills.

According to some embodiments of the present disclosure, the rules in the system may be for example, lunch activity related rule may be that its duration is 45 minutes starting at the middle of the shift with a slack time of 30 minutes before or after. Accordingly, the plurality of updated-schedule-state nodes may be generated.

According to some embodiments of the present disclosure, each edge in the directed-graph of the plurality of updated-schedule-state nodes may indicate a cost of the change in agents-activities by moving between two nodes in the directed-graph of updated-schedule-state nodes.

According to some embodiments of the present disclosure, a model to predict a Service Level Agreement (SLA) level based on actual staffing in each updated-schedule-state node in the generated directed-graph, may be applied for each node in the directed-graph of a plurality of updated-schedule-state nodes.

According to some embodiments of the present disclosure, a heuristic search graph algorithm, such as A* search, may be applied on the generated directed-graph of the plurality of updated-schedule-state nodes based on the SLA level of each updated-schedule-state node in the generated directed-graph as a heuristic, to yield a path in the directed-graph of updated-schedule-state nodes. The path may be combined of one or more edges.

According to some embodiments of the present disclosure, the changes to schedules and the updated schedules may be stored in a database, such as output S3 bucket 140b and such as agents-database 140 in FIG. 1A.

According to some embodiments of the present disclosure, update schedules with optimization results 150b may be pushed to the system, and then, notifications may be automatically sent to a computerized-device of each agent to update the agent with the new schedule of the shift.

According to some embodiments of the present disclosure, the updated schedules may be stored in a database, such as agents-database 140 in FIG. 1A, based on the change in agents activities of each edge in the yielded path in the updated-schedule-state nodes in the path.

FIGS. 2A-2B schematically illustrate a high-level flowchart of a computerized-method for operating intraday schedule optimization in real-time for a schedule having one or more time-intervals, in a contact-center, in accordance with some embodiments of the present invention.

According to some embodiments of the present disclosure, operation 210 comprising retrieving current-state data of the contact center for each time-interval in the schedule, from an agents-database. The current-state data may include staffing requirements for each skill, agents activities, and agents skills for each agent.

According to some embodiments of the present disclosure, operation 220 comprising generating a current-schedule-state node that includes the received current-state data of the contact center.

According to some embodiments of the present disclosure, operation 230 comprising generating a directed-graph of a plurality of updated-schedule-state nodes. Each updated-schedule-state node in the updated-schedule-state nodes indicates a state of the contact-center represented after a change in agents activities and a distance between actual staffing and the staffing requirements for all skills, and each edge in the directed-graph of the plurality of updated-schedule-state nodes indicates a cost of the change in agents-activities by moving between two nodes in the directed-graph of updated-schedule-state nodes.

According to some embodiments of the present disclosure, operation 240 comprising applying a model to predict a Service Level Agreement (SLA) level for each updated-schedule-state node in the generated directed-graph.

According to some embodiments of the present disclosure, operation 250 comprising applying a heuristic search graph algorithm on the generated directed-graph of the plurality of updated-schedule-state nodes based on the SLA level of each updated-schedule-state node in the generated directed-graph as a heuristic to yield a path in the directed-graph of updated-schedule-state nodes. The path is combined of one or more edges.

According to some embodiments of the present disclosure, operation 260 comprising updating the schedule in the contact center based on the change in agents activities of each edge in the yielded path in the updated-schedule-state nodes in the path.

FIG. 3 schematically illustrates a directed-graph 300, in accordance with some embodiments of the present invention.

According to some embodiments of the present disclosure, the schedule of the contact center may be modeled as a node in a directed-graph. Each node in the graph may represent a state that the contact center is in. One or more updated-schedule-state nodes in the plurality of updated-schedule-state nodes may be successors of the current-state node, and the one or more updated-schedule-state nodes may be predecessors of other updated-schedule-state nodes in the plurality of updated-schedule-state nodes.

According to some embodiments of the present disclosure, the node may include data of the schedule that the agents are scheduled to work with the time and location, the available personnel, e.g., the agents and their related skills and staffing requirements.

According to some embodiments of the present disclosure, the staffing requirements may be the number of agents required to the contact center across the different skills and the actual staffing may be the agents assigned to the schedule and the corresponding skills.

According to some embodiments of the present disclosure, a system, such as system 100A in FIG. 1A and such as system 100B in FIG. 1B, may optimize the schedule as to best fit the staffing requirements.

According to some embodiments of the present disclosure, possible changes to the schedule, e.g., actions that their implementation may optimize the schedule may be represented by edges in the directed-graph. For example, extending the break of an agent may lead to a different state with a different schedule. At each point, a multitude of different possible schedule changes that can be made, in accordance with the limitations caused by contact center configurations and the local law, and the like, may be considered. All these schedule changes may be represented as outgoing edges out of the current state node 310. For example, nodes 320-340.

According to some embodiments of the present disclosure, a series of changes may be represented as a path on the directed-graph 300, traversing the nodes from one state to a different one, through a sequence of steps.

According to some embodiments of the present disclosure, the optimization of the schedule in real-time may be operated by generating a directed-graph of a plurality of updated-schedule-state nodes. Each updated-schedule-state node in the updated-schedule-state nodes may indicate a state of the contact-center represented after a change in agents activities and a distance between actual staffing and the staffing requirements for all skills. An optimized schedule is a schedule that the actual number of agents and related skills is the nearest to staffing requirements and the SLA level is closest to a preconfigured SLA-threshold.

According to some embodiments of the present disclosure, each edge in the directed-graph of the plurality of updated-schedule-state nodes may indicate a cost of the change in agents-activities by moving between two nodes in the directed-graph of updated-schedule-state nodes. The edges in the direct graph may be possible actions to change the schedule. For example, rescheduling an agent's lunch break.

According to some embodiments of the present disclosure, the directed-graph 300 may be a search graph. Each node, i.e., vertex in the graph may represent a schedule state. The schedule state may include staffing requirements, which is the number of agents which are required at each time interval, for each skill, the agent schedules, e.g., actual staffing and activity type of the agent. The activity type may be for example, open to receive interactions, lunch, break, training and the like.

According to some embodiments of the present disclosure, the schedule state may further include the agents skills, for example, one agent may work only on technical support while another agent may work on technical support and billing and the number of training sessions that may be added to the schedule for each agent.

According to some embodiments of the present disclosure, the heuristic function may include the following parameters:
D(v) which is the negative utility of a state as a function of the difference between actual staffing and staffing requirements,
C(e) which is the cost of an action, e.g., a change to the schedule.

According to some embodiments of the present disclosure, C, D can be adjusted to reflect different preferences. Multiple different solutions may be used to provide multi-skilled D values such as dedicated heuristic or ML model. For example, when there is an agent with more than one skill, it may be more complicated to determine staffing accuracy. An agent having two skills doesn't evenly split the time between the two skills. Agents with more than one skill worth more to the contact center because the availability allows the contact center to achieve more.

According to some embodiments of the present disclosure, system 100A in FIG. 1A may operate intraday schedule optimization in real-time for a schedule having one or more time-intervals, in a contact-center by applying a heuristic search graph algorithm to search for the best path in the directed-graph.

According to some embodiments of the present disclosure, for example, the heuristic search graph algorithm may be A*-search algorithm and beam-search. The best path may be a path that minimizes D(destination)+Σ_{e∈path}C(e). The path may be combined of one or more edges, each edge in the directed-graph of the plurality of updated-schedule-state nodes may indicate a cost of the change in agents-activities by moving between two nodes in the directed-graph of updated-schedule-state nodes.

According to some embodiments of the present disclosure, the optimized schedule may be a result of the changes to the current state schedule based on the best path found by the heuristic search graph algorithm.

According to some embodiments of the present disclosure, the heuristic may be the SLA level which may be based on an estimation of the time distributions of the agents. That can be achieved by splitting the agent's time between all the skills equivalently, or proportionally to their forecasted workload. The staffing is then subtracted from the requirements and the difference is then multiplied by a user-configurable parameter. For example, understaffing may be considered as twice important than overstaffing when the user-configurable parameter is 2.

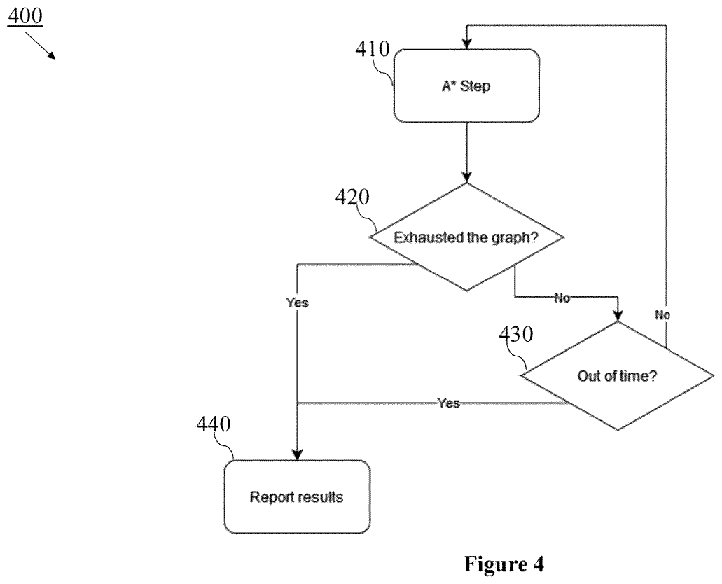

FIG. 4 schematically illustrates a high-level flowchart 400 of heuristic search graph algorithm, in accordance with some embodiments of the present invention.

According to some embodiments of the present disclosure, the heuristic search graph algorithm may be for example A*-search algorithm 410. The heuristic search graph algorithm may be applied on a directed-graph, such as directed-graph 300 in FIG. 3. Each node in the graph may represent the state of the contact center represented after a change in agents activities and a distance between actual staffing and the staffing requirements for all skills. Each edge in the directed-graph of the plurality of updated-schedule-state nodes may indicate a cost of the change in agents-activities by moving between two nodes in the directed-graph of updated-schedule-state nodes.

According to some embodiments of the present disclosure, for example, move agent ‘A’ lunch from 12:00 to 13:00, a change that changes the state of the contact center, e.g., updated-schedule-state and may lead from the current node, e.g., current-schedule-state to a new node representing the new state, i.e., updated-schedule-state node.

According to some embodiments of the present disclosure, the heuristic search graph algorithm, such as A*-search algorithm may be an iterative algorithm which may heuristically find the shortest path in the directed-graph of the plurality of updated-schedule-state nodes to a target node in a graph. Thus, the schedule optimization may be converted into a pathfinding in the graph by looking for a minimal path represented by C to a node with the optimized schedule, which may be represented by D.

According to some embodiments of the present disclosure, even though there may not be a node with an optimized schedule in the directed-graph, or a node that is worth the cost of the actions which are required to achieve it, a path that leads to a better schedule than the current-schedule-state while not incurring too costs above a predefined threshold may be found.

According to some embodiments of the present disclosure, the A* algorithm may terminate when a path to the destination, e.g., optimized schedule is found. Since the destination might not exist, the A*-search algorithm may not terminate until the entire directed-graph is exhausted 420, which may take a lot of time.

According to some embodiments of the present disclosure, for that purpose of run-time above a preconfigured run-time threshold a A* heap may be detected as being empty, after which the A* loop will terminate. However, at each iteration, the algorithm may try to visit nodes closer to the destination, thus the algorithm may improve improving over time or not deteriorate.

According to some embodiments of the present disclosure, optionally, the A*-search algorithm may run for a preconfigured amount of time 430 and may report the best path found to the user when that time is over. After each iteration in the A* loop, the total run-time of the algorithm may be checked against the preconfigured amount of time. If the algorithm still has time left and the directed-graph is not exhausted, it may perform another A* loop iteration. Otherwise, the algorithm may report the results to the user.

According to some embodiments of the present disclosure, the schedule may be updated in a database, such as the agents-database 140 in FIG. 1A based on the results, e.g., the change in agents activities of each edge in the yielded path in the updated-schedule-state nodes in the path. According to some embodiments of the present disclosure, should the user require a better solution, the A* search can be resumed for a specified amount of time. At each iteration, the visited node with the lowest score (D(node)+Σ(e∈path) C(e)) and the edge that lead to that node, may be stored in a database.

According to some embodiments of the present disclosure, to report the results of the search to the user, combining the edges to the initial node, e.g., current schedule state. The plan can be displayed graphically by listing all the actions, e.g., changes to eh schedule and the destination state's schedule.

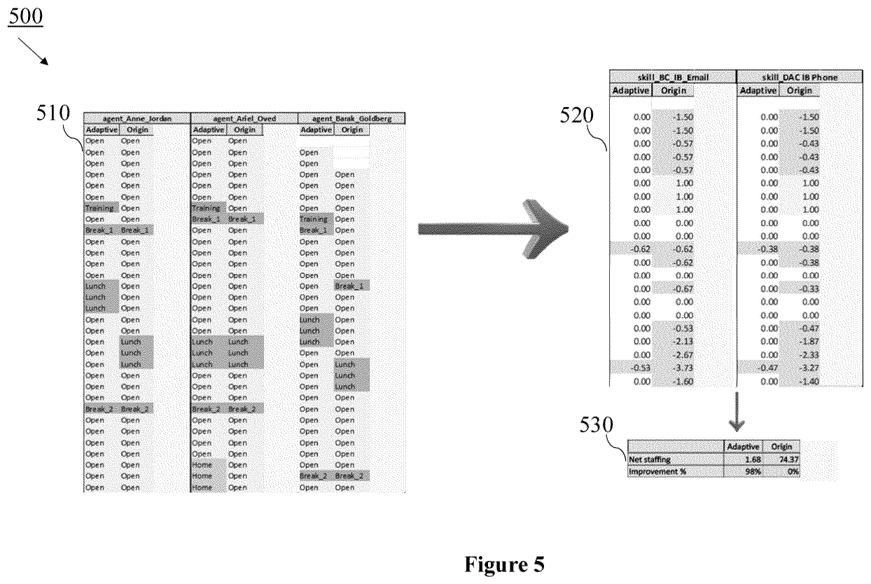

FIG. 5 shows schedules before optimization and after, in accordance with some embodiments of the present invention;

According to some embodiments of the present disclosure, in table 510 the schedule of two agents before operating intraday schedule optimization in real-time for a schedule having one or more time-intervals and after is displayed. For example, the schedule of agent Anne Jordan may include the following changes after the intraday schedule optimization. Training instead of open activity type, 3 time-intervals of lunch instead of open activity type, and 3 time-intervals of open activity instead of originally scheduled lunch.

According to some embodiments of the present disclosure, table 510 shows that after the operation of the intraday schedule optimization in real-time for a schedule having one or more time-intervals the schedule of agent Ariel Oved has been changed at the end of the shift such that the agent has been sent home earlier.

According to some embodiments of the present disclosure, table 520 shows the change in net staffing for email skill and phone skill in each time-interval in the schedule. In this schedule optimization, most time-intervals have been changed such that the net staffing is zero.

According to some embodiments of the present disclosure, table 530 shows a summary of the total net staffing of each time-interval of the schedule before and after the schedule optimization and the improvement percentage.

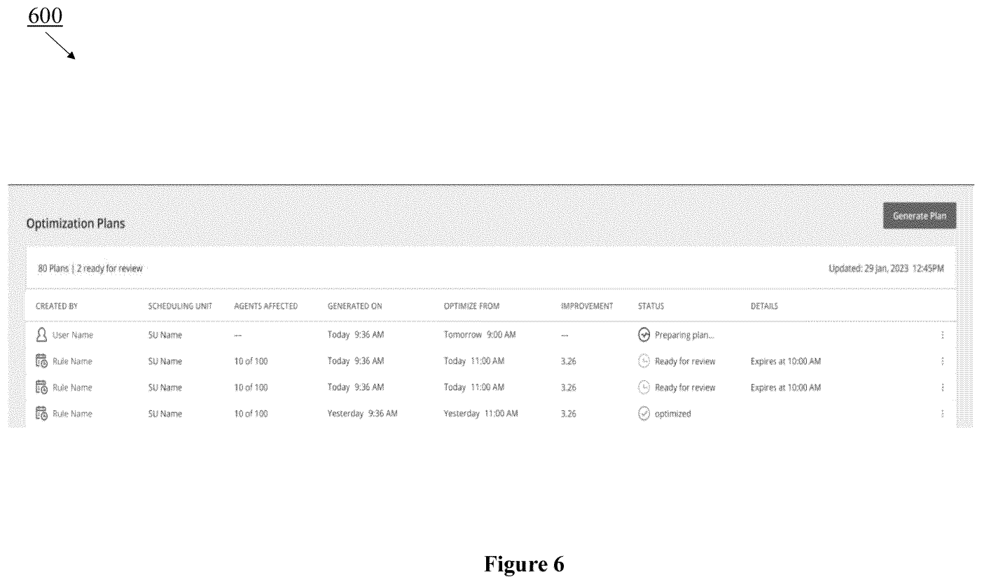

FIG. 6 is a screenshot of User Interface (UI) 600 to track optimization plans, in accordance with some embodiments of the present invention.

According to some embodiments of the present disclosure, UI 600 shows a screenshot of optimization plans that include schedule changes. Each plan has a status which may be ready for review and pending a user to accept the changes, optimized and in progress, e.g., preparing plan. The plans represent optimization suggestion to the schedule.

According to some embodiments of the present disclosure, optionally, users may be required to either accept a plan which will then update agents schedules or ignore it, which will leave the current state as it is.

According to some embodiments of the present disclosure, the schedule may be automatically updated in the agents-database based on the change in agents activities of each edge in the yielded path in the updated-schedule-state nodes in the path. Optionally, the schedules may be automatically updated when the optimization score of the schedule may be above a preconfigured threshold.

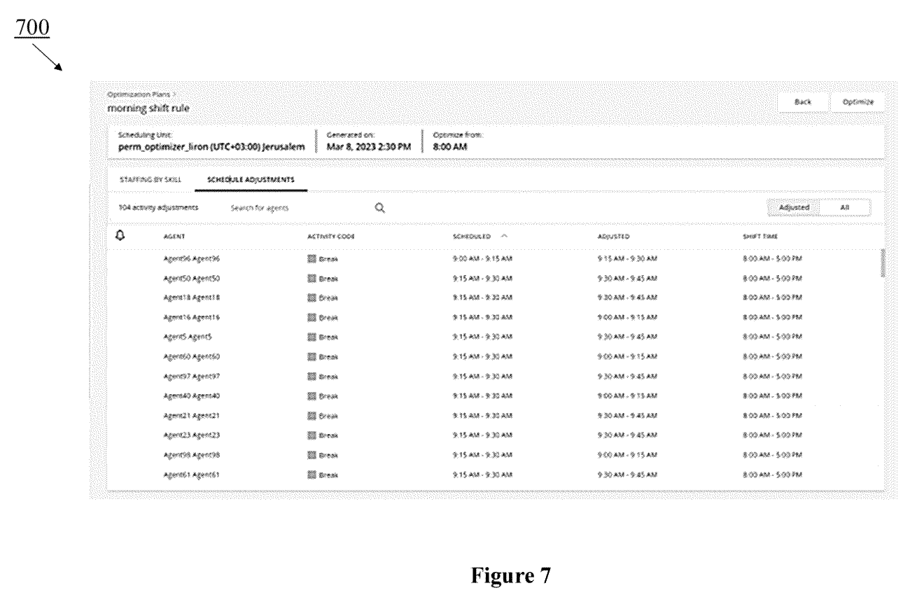

FIG. 7 is a screenshot of a UI 700 of a schedule adjustment, in accordance with some embodiments of the present invention.

According to some embodiments of the present disclosure, UI 700 shows a screenshot of a plan to adjust a schedule after operating an intraday schedule optimization in real-time for a schedule having one or more time-intervals.

According to some embodiments of the present disclosure, the plan details may be presented on the agent level, per activity code, listing the total schedule activity changes made to the schedule as part of one optimization job.

According to some embodiments of the present disclosure, the changes to the schedule may be presented alongside current state schedule.

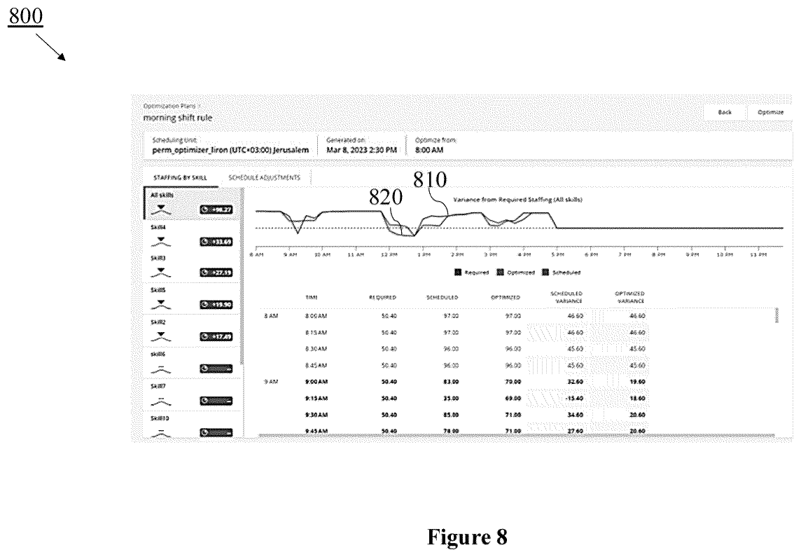

FIG. 8 is a screenshot of a UI 800 of the schedule adjustment with a graph showing the variance from required staffing, in accordance with some embodiments of the present invention.

According to some embodiments of the present disclosure, UI 800 shows results of schedule optimization on skills level. Line 810 shows variance of actual scheduled from required staffing and line 820 shows variance of optimized schedule from the required staffing.

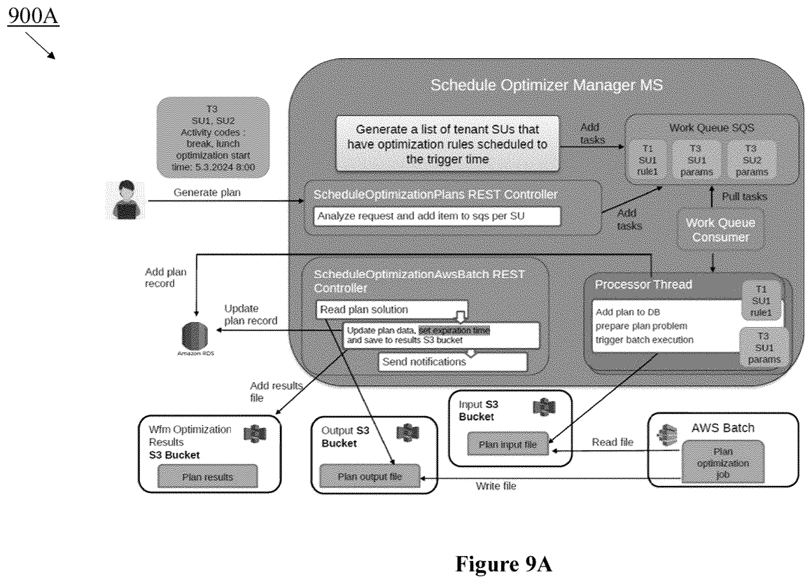

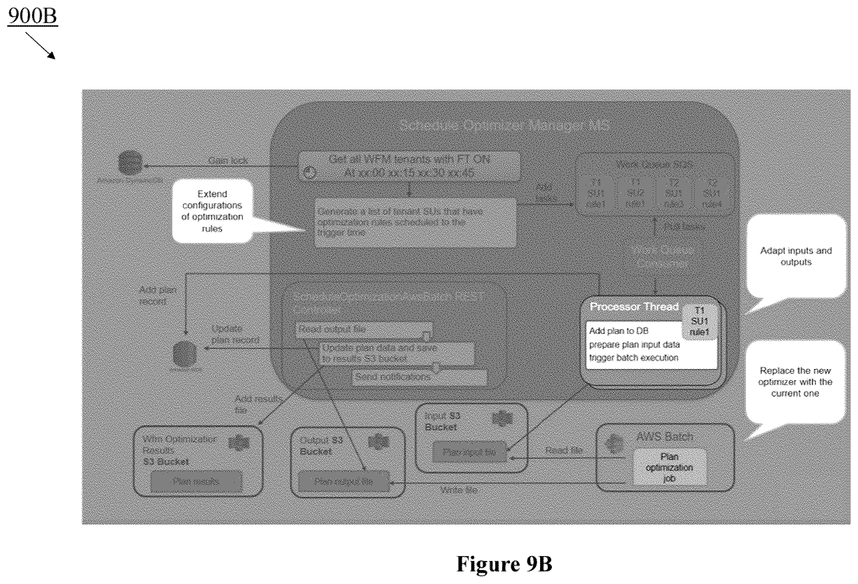

FIG. 9A schematically illustrates a high-level diagram 900A of schedule optimizer manager, in accordance with some embodiments of the present invention.

According to some embodiments of the present disclosure, a system, such as system 100A, may operate an intraday schedule optimization in real-time for a schedule having one or more time-intervals, by an optimization job execution. The system 100A may be implemented on a cloud computing service provider platform, such as Amazon Web Services (AWS) platform.

According to some embodiments of the present disclosure, the optimization job may be added to a queue, such as Amazon® Simple Queue Service (SQS). The optimization may be triggered either automatically by the system or manually on demand by a user. Once the system identifies the optimization that is required the optimization is required, a request for a new job is added to the queue.

According to some embodiments of the present disclosure, preparation of the data for the construction of a plan for schedule optimization may include extraction of agents lists, the schedules, e.g., all of the agents shifts and activities within the shifts, agents skills, agents working rules, which include the definition of the activity type police, such as the lunch and break policy, number of extra hours per week and month for each agent and the like. The current staffing information per each time-interval e.g., 15 minutes of the day, what is the expected staffing requirements and what is the current scheduled time.

According to some embodiments of the present disclosure, when the data preparation may be ready a plan input file is added to S3 bucket for the operating of the intraday schedule optimization in real-time for a schedule having one or more time-intervals.

According to some embodiments of the present disclosure, once the optimized schedule is available it may be stored in the output S3 bucket, such as output S3 bucket 140b in FIG. 1B and the “ScheduleOptimizationController” may read the plan of changes in agents activities and may update the schedule in the agents-database.

According to some embodiments of the present disclosure, optionally, the “ScheduleOptimizationController” may automatically send a notification to a computerized-device of a user, e.g., manager by presenting the plan via a UI, e.g., UI 600 in FIG. 6 and such as UI 700 in FIG. 7.

FIG. 9B schematically illustrates a high-level diagram 900B of schedule optimizer manager, in accordance with some embodiments of the present invention.

According to some embodiments of the present disclosure, a system, such as system 100A in FIG. 1A may be deployed in a cloud-based contact center in a cloud computing environment.

According to some embodiments of the present disclosure,

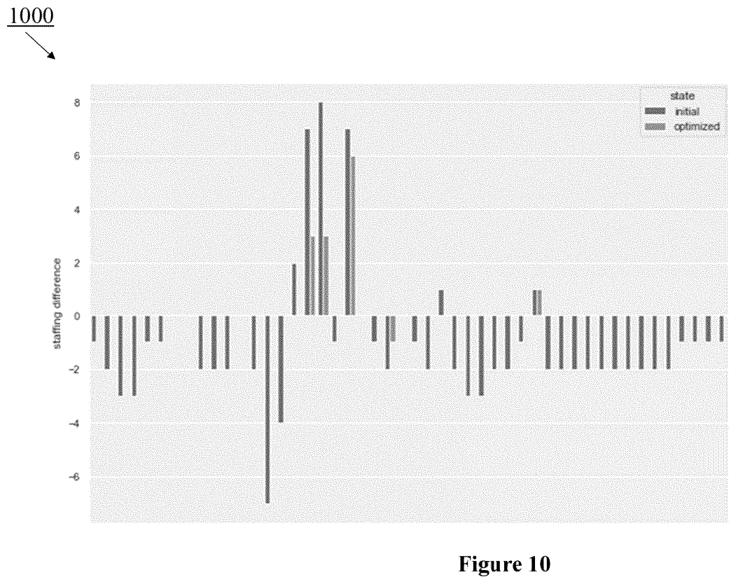

FIG. 10 shows a graph 1000 of results of schedule optimization, in accordance with some embodiments of the present invention.

According to some embodiments of the present disclosure, for example, system 100A may synthesize a schedule for 10 agents with an average of 1.5, e.g., 15% understaffed agents and 0.5, e.g., 5% overstaffed agents at the time-interval level. Optimization resulted in a multi-action plan that reduced these to an average of 0.02 (0.04%) missing agents and 0.27 (0.5%) overstaffed agents at the time-interval level.

According to some embodiments of the present disclosure, the initial staffing is shown and the optimized staffing after operating intraday schedule optimization in real-time for a schedule having one or more time-intervals. Each bar in the graph 1000 shows the staffing difference in a time-interval of 15-minutes interval within a single shift. Optimal staffing as at y=0—when y<0 the center is understaffed and when y>0 the center is overstaffed. The graph 1000 shows an improvement at every time-interval. While at most time-intervals the staffing does not require optimization, in areas where the optimization didn't reach 0 it improved or didn't worsen the schedule, and it made an improvement by reducing understaffing and overstaffing scenarios with the resources, e.g., agents it has.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for operating intraday schedule optimization in real-time for a schedule having one or more time-intervals, in a contact-center, said computerized-method comprising:
(i) retrieving current-state data of the contact center for each time-interval in the schedule, from an agents-database,
wherein current-state data comprising: a) staffing requirements for each skill; b) agents activities; and c) agents skills for each agent;
(ii) generating a current-schedule-state node that includes the received current-state data of the contact center;
(iii) generating a directed-graph of a plurality of updated-schedule-state nodes,
wherein each updated-schedule-state node in the updated-schedule-state nodes indicates a state of the contact-center represented after a change in agents activities and a distance between actual staffing and the staffing requirements for all skills, and wherein each edge in the directed-graph of the plurality of updated-schedule-state nodes indicates a cost of the change in agents-activities by moving between two nodes in the directed-graph of updated-schedule-state nodes,
(iv) applying a model to predict Service Level Agreement (SLA) level for each updated-schedule-state node in the generated directed-graph;
(v) applying a heuristic search graph algorithm on the generated directed-graph of the plurality of updated-schedule-state nodes based on the SLA level of each updated-schedule-state node in the generated directed-graph as a heuristic to yield a path in the directed-graph of updated-schedule-state nodes,
wherein the path is combined of one or more edges, and
(vi) updating the schedule in the contact center based on the change in agents activities of each edge in the yielded path in the updated-schedule-state nodes in the path.

2. The computerized-method of claim 1, wherein the model to predict the SLA level is at least one of: (i) Machine Learning (ML) model; (ii) Erlang C formula; and (iii) simulations of incoming interactions and related expected length with agents.

3. The computerized-method of claim 1, wherein the heuristic search graph algorithm is using the SLA level of each updated-schedule-state node as heuristic by comparing the SLA level of each updated-schedule-state node to a preconfigured target-SLA level.

4. The computerized-method of claim 1, wherein the current state data further comprising activities which are not in the schedule for each agent.

5. The computerized-method of claim 1, wherein the heuristic search algorithm is A*-search algorithm.

6. The computerized-method of claim 1, wherein said agents activities are one of: (i) open to receive interactions from customers; (ii) break; (iii) training; (iv) lunch; (v) Voluntary Time-Off (VTO); and (e) extra-hours.

7. The computerized-method of claim 1, wherein said heuristic search graph algorithm on the generated directed-graph of updated-schedule-state nodes comprising:
(i) extending the updated-schedule-state node having the SLA level above the preconfigured SLA-threshold in the directed-graph of updated-schedule-state nodes and minimum accumulated cost to yield the path from the current-state node to the updated-schedule-state node having the SLA level above the preconfigured SLA-threshold; and
(ii) storing all updated-schedule-state nodes in a database as the path.

8. The computerized-method of claim 1, wherein the cost of moving between two nodes in the directed-graph of updated-schedule-state nodes indicates cost of the change in agents activities and it is determined by a preconfigured dictionary of action costs.

9. The computerized-method of claim 7, wherein the extending of the updated-schedule-state node having the SLA level above the preconfigured SLA-threshold is operated during a running-time limit and when there is no updated-schedule-state node having an SLA level above the preconfigured SLA-threshold during the running-time limit:
(i) extending the updated-schedule-state node having the SLA level in a preconfigured distance below the SLA level and the minimum accumulated cost to yield the path from the current-state node to the updated-schedule-state node having the SLA level in the preconfigured distance below the SLA level; and
(ii) storing all updated-schedule-state nodes in a database as the path.

10. The computerized-method of claim 1, wherein said computerized-method further comprising applying the model to predict the SLA level for the current state of the contact-center based on the received current state data and operating the generating of the directed-graph of the plurality of updated-schedule-state nodes when the yielded SLA level is below a preconfigured SLA-threshold.

11. The computerized-method of claim 1, wherein one or more updated-schedule-state nodes in the plurality of updated-schedule-state nodes are successors of the current-state node, and the one or more updated-schedule-state nodes are predecessors of other updated-schedule-state nodes in the plurality of updated-schedule-state nodes.

12. The computerized-method of claim 1, wherein the updating of the schedule in the contact center is operated via a Workforce Management (WFM) application.
